(19) United States
(12) Patent Application Publication
(10) Pub. No.: US 2010/0127670 A1
(43) Pub. Date: May 27, 2010

(54) BATTERY CHARGING SYSTEM HAVING HIGH CHARGE RATE

(75) Inventors: Ke-Horng Chen, Taipei County (TW); Hong-Wei Huang, Taichung County (TW); Chia-Hsiang Lin, Taipei City (TW); Hsing-Yi Chen, Hsinchu County (TW)

Correspondence Address: J C PATENTS, 4 VENTURE, SUITE 250, IRVINE, CA, 92618, US

(73) Assignee: FARADAY TECHNOLOGY CORP., Hsinchu (TW)

(21) Appl. No.: 12/275,837

(22) Filed: Nov. 21, 2008

(51) Int. Cl. H02J 7/06

(52) U.S. Cl. 320/163

(57) ABSTRACT

A charger including a regulator, a controller and a compensation-adjusting unit for accurately charging to a battery device is provided. The regulator provides a charging current to the battery device. The controller is coupled to the regulator for controlling the charging current. The compensation-adjusting unit is coupled to the regulator and the battery device for receiving a first reference voltage. In a first operation mode, the compensation-adjusting unit outputs the first reference voltage to the regulator. In a second operation mode, the controller instructs the regulator to transiently generate a first charging current and a second charging current. Responsive to the first and the second charging currents, the output voltage of the battery device presents a first output voltage and a second output voltage. The compensation-adjusting unit pre-estimates a parasitic resistance of the battery device by detecting the first and the second output voltage, thus compensating the first reference voltage.

### BACKGROUND OF THE INVENTION

1. Field of the Invention

The present invention generally relates to a battery charging system having a high charge rate, and more particularly, to a fast battery charger which is capable of automatically measuring a battery internal impedance for providing a compensation.

2. Description of Related Art

Portable electronic products are now very welcome and highly popularized. Accordingly, lower power consumption and higher efficiency are often primarily considered when evaluating a portable electronic product. Typically, such a portable electronic product contains circuits consuming power provided by a battery. These circuits usually work under a low voltage and a low current so as to consume less power, thus elongating a working time of the battery. As such, effective power management has been considered as playing a key role in designing an electronic circuit.

In order to save power consumption, a regulator is often employed for lowering an operation voltage. The regulator is adapted for converting a relative high input voltage into a relative low voltage, and providing the relative low voltage to other circuits for use. Typically, the regulator can be configured in three architectures: switch type regulator, DC-DC converter, and linear regulator. Nowadays, low dropout (LDO) linear regulators are more important than other regulators, especially when used in portable electronic products. An LDO linear regulator has the advantages of faster response of the output voltage to the variation of the input voltage or the load, lower ripple and noise of the output voltage, simple circuit structure, smaller size, and cheaper cost. Recently, the LDO linear regulators are developed to achieve a higher conversion efficiency, and therefore become a mainstream of the regulators.

As shown in FIG. 1A, an LDO linear regulator 100 includes a transmission unit 110, resistive dividers 120 and 130, and an amplifier 140. The transmission unit 110 can be a transistor as shown in FIG. 1A. The transistor includes a gate coupled to an output terminal of the amplifier 140, a source coupled to an input voltage Vi, and a drain coupled to an end of the resistive divider 120. The voltage of the drain is equal to an output voltage Vo. The other end of the resistive divider 120 is coupled to a non-inverting input terminal of the amplifier 140. One end of the resistive divider 130 is also coupled to the non-inverting input terminal of the amplifier 140, and another end of the resistive divider is grounded. An inverting input terminal of the amplifier 140 is coupled to a reference voltage Vr.

When an LDO linear regulator is employed inside a charger, a battery pack 150 can be simulated by a parasitic resistor 151 and a battery 152. The battery 152 is represented with a capacitor symbol in FIG. 1A, while the charging current flowing through the battery pack 150 is represented as I_{CH}. A variation of the charging mode of the charger is illustrated in FIG. 1B. Referring to FIG. 1B, at the beginning, the LDO linear regulator 100 charges the battery pack 150, with a trickle mode, to a first predetermined voltage Vp1. Then, the LDO linear regulator 100 switches to a constant current mode for further charging the batter pack 150. When the battery pack 150 is charged to a second predetermined voltage Vp2, the LDO linear regulator 100 further switches to a constant voltage mode to regulate the voltage of the battery pack 150 at the second predetermined voltage Vp2.

However, this charging method has an outstanding disadvantage. For example, when a voltage applied over the two ends of the battery pack 150 reaches the second predetermined voltage Vp2, (i.e., the external voltage applied to the battery pack 150 is detected as having reached the second predetermined voltage Vp2), while the real voltage of the battery 152 does not really reach the second predetermined voltage Vp2. Therefore, in this case, the real voltage of the battery 152 is equal to the second predetermined voltage Vp2 having a voltage drop over the parasitic resistor 151 (also known as a current resistor voltage drop, IR drop). In order to exactly charge the batter 152 to the second predetermined voltage Vp2 as desired, before switching to the constant voltage mode, the charger remains charging the battery 152 with a gradually reduced charging current I_{CH}, till the charging current I_{CH} is reduced to be less than a specific value. Therefore, the value of the IR drop determines the length of the charging time.

Regarding this disadvantage, the conventional charging circuit as shown in FIG. 1 has been proposed to be modified as shown in FIG. 2. Referring to FIG. 2, the charging circuit further employs two inductive resistors 160 and 170. It can be supposed that the resistances of the resistive dividers 120 and 130 are R₁₂₀ and R₁₃₀, respectively, and the resistances of the inductive resistors 160 and 170 are R₁₆₀ and R₁₇₀, respectively. When the current flowing through the battery pack 150 is I_{CH}, the output voltage Vo can be represented by equation (1) as following.

$$Vo = Vr \times ( 1 + \frac{{R}_{120}}{{R}_{130}} + \frac{{R}_{120}}{{R}_{160}} ) + {I}_{CH} \times {R}_{170} \times \frac{{R}_{120}}{{R}_{160}} \qquad ( 1 )$$

The equation (1) satisfies two boundary conditions. When the current I_{CH}=0, Vo is equal to the second predetermined voltage Vp2, and when the current I_{CH} reaches a maximum value, Vo is equal to a sum of the second predetermined voltage Vp2 and a IR drop to be compensated. In such a way, when the charger switches to the constant voltage mode, an error between the voltage of the battery 152 and the second predetermined voltage Vp2 can be reduced.

However, the charging circuit shown in FIG. 2 still has a disadvantage, in that the resistance value of parasitic resistor 151 of the battery pack 150 must be measured in advance and the IR drop can be obtained according to the maximum charging current I_{CH} subsequently. Therefore, the resistance values (R₁₂₀, R₁₃₀, and R₁₆₀, R₁₇₀) of the resistive dividers 120, 130, and the inductive resistors 160, 170, can be obtained in accordance with the equation (1). Unfortunately, different battery packs have different parasitic resistances, which raise the uncertainty of the resistance values R₁₆₀, R₁₇₀ of the inductive resistors 160, 170, so that it is hard to further improve the charging efficiency.

### SUMMARY OF THE INVENTION

Accordingly, the present invention is directed to provide a charger, adapted for pre-estimating a parasitic resistance of a battery device for providing a compensation thereto. The charger is featured with an improved charging rate, and an improved charging efficiency.

The present invention provides a battery charging system. The battery charging system includes a low dropout (LDO) linear regulator, a controller, and a compensation adjusting unit. The LDO linear regulator provides a charging current to a battery device. The controller is coupled to the LDO linear regulator for controlling the charging current outputted from the LDO linear regulator. The compensation adjusting unit is coupled to the LDO linear regulator and the battery device for receiving a first reference voltage.

When the charger enters a first operation mode, the compensation adjusting unit outputs the first reference voltage to the LDO linear regulator. When the charger enters a second operation mode, the controller instructs the LDO linear regulator to transiently generate a first charging current and a second charging current. Responsive to the first charging current and the second charging current, an output voltage of the battery device presents to be a first output voltage and a second output voltage, respectively. The compensation adjusting unit pre-estimates a resistance value of a parasitic resistance of the battery device by detecting the first output voltage and the second output voltage, so as to compensating the first reference voltage.

According to an embodiment of the present invention, the compensation adjusting unit includes a voltage compensation unit and a voltage level adjusting unit. The voltage compensation unit is coupled to the LDO linear regulator. The voltage compensation unit outputs an output signal related to a difference between the first output voltage and the second output voltage. The voltage level adjusting unit receives the output signal outputted from the voltage compensation unit for compensating the first reference voltage.

According to an embodiment of the present invention, the voltage level adjusting unit includes a voltage-to-current converter, an inverter chain, a digital current source, and a voltage accumulation unit. The voltage-to-current converter is coupled to the voltage compensation unit for converting the output signal outputted from the voltage compensation unit into a first current. The inverter chain is coupled to the voltage-to-current converter for converting the first current into a digital code. The digital current source is coupled to the inverter chain for determining a second current according to the digital code. The voltage accumulation unit is coupled to the digital current source, and is adapted for outputting a compensation voltage according to the second current. The compensation voltage is provided for compensating the first reference voltage.

According to an embodiment of the present invention, the voltage accumulation unit includes an operational amplifier and a resistor. The operational amplifier includes a first input terminal, a second input terminal, and an output terminal. The first input terminal of the operational amplifier is coupled to the first reference voltage. The second input terminal of the operational amplifier is coupled to the output terminal of the operational amplifier. One end of the resistor receives the second current, and another end of the resistor is coupled to the output terminal of the operational amplifier. The compensation voltage is related to a voltage drop over the resistor.

The present invention also provides a method of providing a battery device with a charging current for compensating a parasitic resistance thereof. The method includes generating an output voltage responsive to the charging current; outputting an output signal related to a difference caused by a transient variation of the output voltage; converting the output signal into a first current; converting the first current into a digital code; determining a second current according to the digital code; and receiving the first reference voltage, and outputting a compensation voltage according to the second current, wherein the compensation voltage is provided for compensating the first reference voltage.

According to an embodiment of the present invention, the method further includes outputting the first reference voltage when entering a first operation mode.

According to an embodiment of the present invention, the method further includes generating a first charging current and a second charging current when entering a second operation mode; presenting a first output voltage and a second output voltage according to the first charging current and the second charging current respectively; and pre-estimating a resistance value of the parasitic resistance of the battery device by detecting the first output voltage and the second output voltage, so as to compensate the first reference voltage.

In summary, the battery charging system according to the embodiments of the present invention is capable of calculating a resistance value of the parasitic resistance of the battery device, and thus obtaining the current resistor voltage drop for compensating. As such, the charger according to the embodiments of the present invention is adapted for accurately charging a battery in a battery device to a specific voltage, with an improved charging performance. Further, the charger according to the embodiments of the present invention is adapted for charging the battery in the battery device to a specific voltage with an improved charge rate, thus saving the time spent on charging.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of a conventional charger.

FIG. 1B is a curve diagram showing charging modes of a conventional charger.

FIG. 2 is a schematic diagram illustrating a modification to the conventional charger.

FIG. 3 is an equivalent circuit diagram of a battery device.

FIG. 4A schematically illustrates a charger charging a battery device according to an embodiment of the present invention.

FIG. 4B is a circuit diagram of a low dropout (LDO) linear regulator provided by an embodiment of the present invention.

FIG. 4C is a circuit diagram of a compensation adjusting unit provided by an embodiment of the present invention.

FIG. 4D is a circuit block diagram of a voltage level adjusting unit provided by an embodiment of the present invention.

FIG. 4E is a circuit diagram of a voltage-to-current converter and an inverter chain provided by an embodiment of the present invention.

FIG. 4F is a circuit diagram of a digital current source provided by an embodiment of the present invention.

FIG. 4G is a circuit diagram of a voltage accumulation unit provided by an embodiment of the present invention.

FIG. 5A illustrates a characteristic curve of the charging current.

FIG. 5B shows characteristic curves of a voltage over two ends of the battery device and a voltage over two ends of the battery, respectively.

FIG. 6 is a circuit diagram of a voltage compensation unit provided by an embodiment of the present invention.

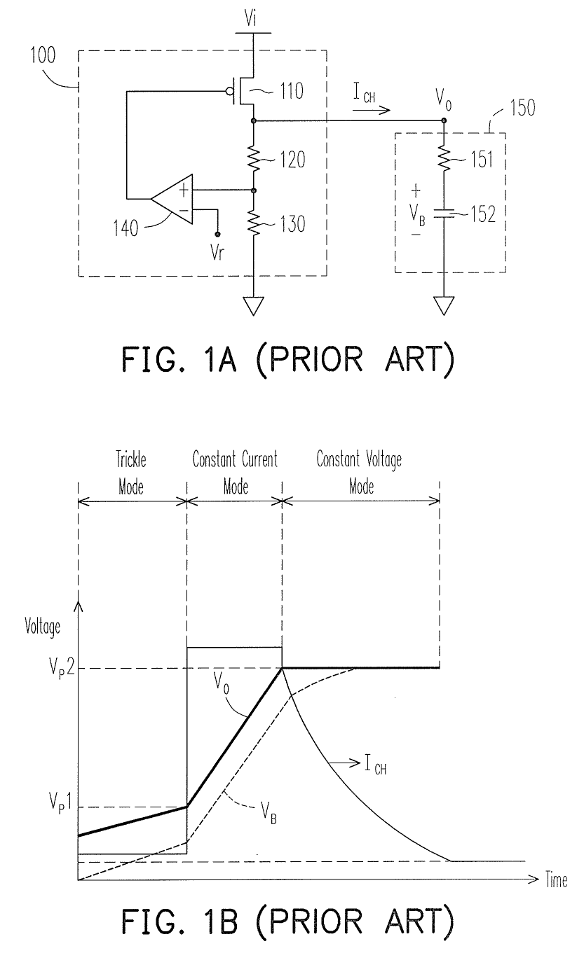

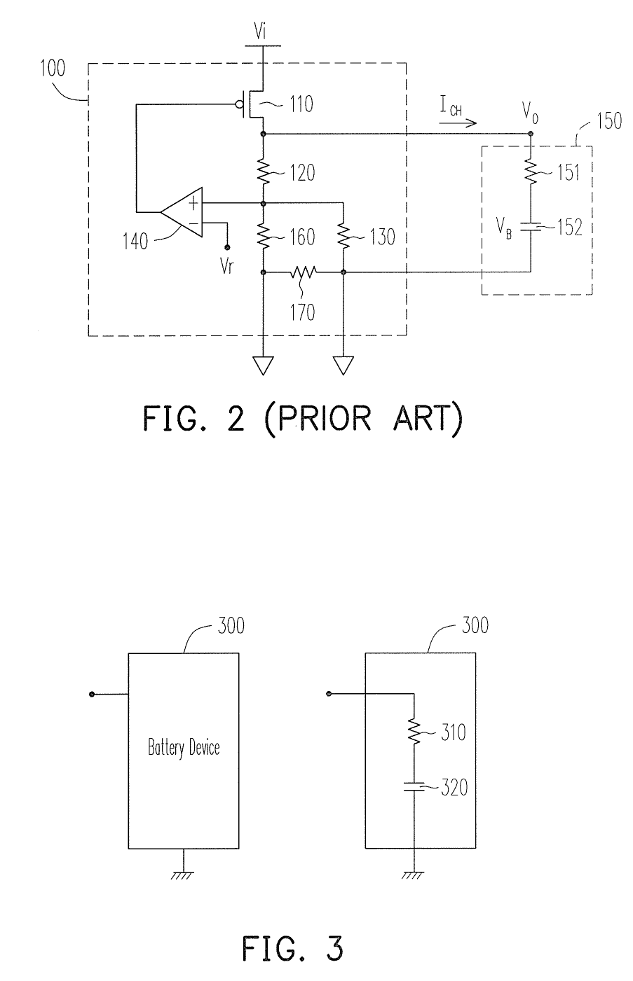

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Generally, a typical battery device includes a battery, and some parasitic resistors, such as battery internal resistances, or contact resistances. As such, the battery device can be equivalently simulated as a parasitic resistor 310 and a battery 320 as shown in FIG. 3. In FIG. 3, the battery 320 is represented with a capacitor symbol. When a current is applied to the battery device 300 for charging, a current resistor voltage drop (IR drop) is caused over the parasitic resistor 310. As such, when a voltage drop over two ends of the battery device 300 is measured to be a specific voltage Vp, a voltage drop two ends of the battery 320 is equal to the specific voltage Vp having the IR drop over the parasitic resistor 310 subtracted therefrom. In order to assure to charge the battery 320 inside the battery device 300 to the specific voltage Vp, the IR drop over the parasitic resistor 310 inside battery device 300 has to be compensated.

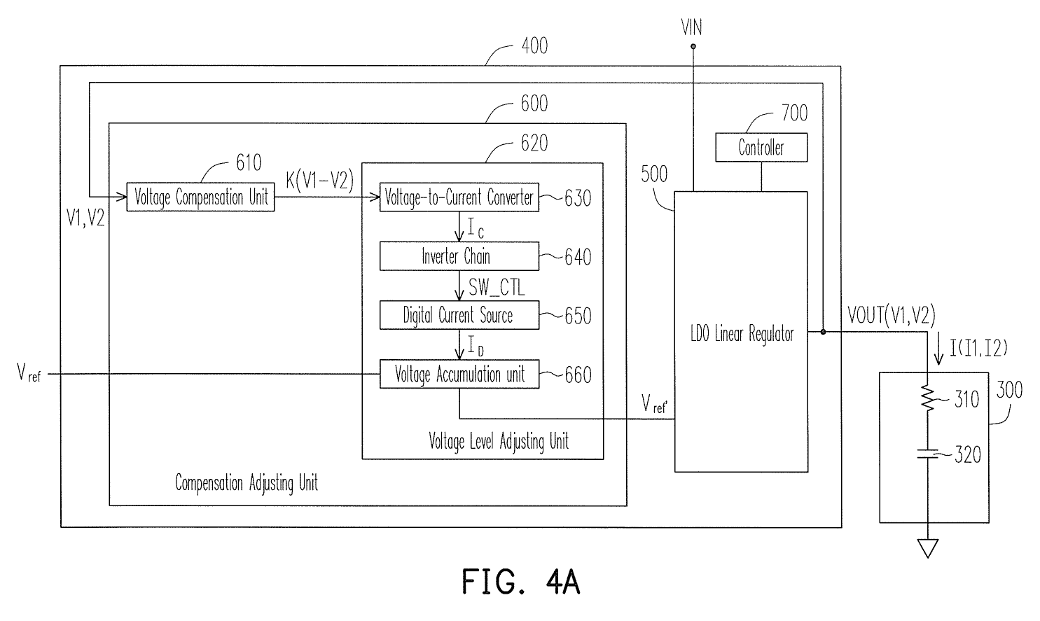

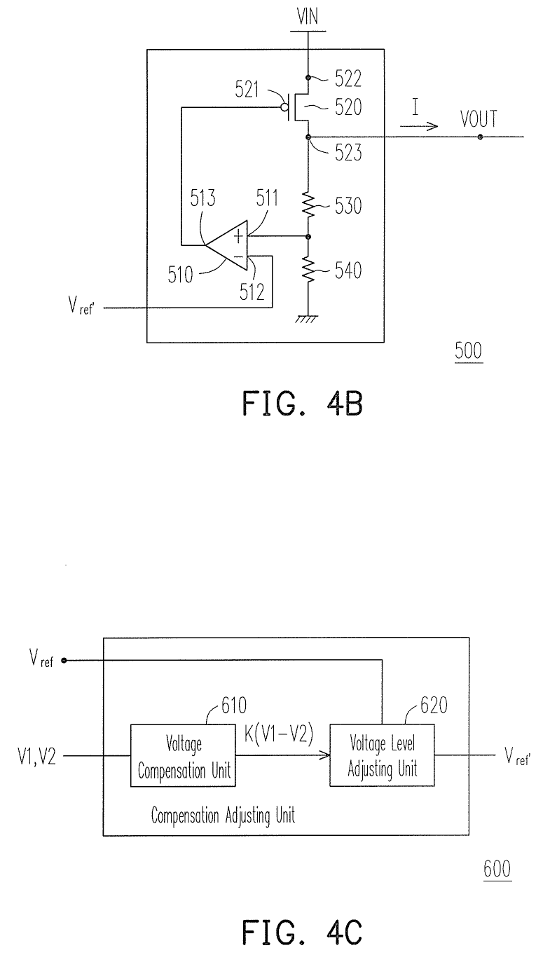

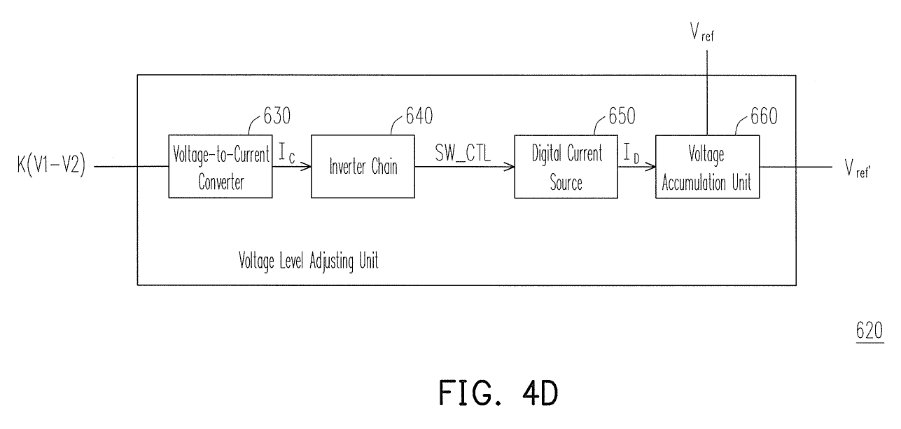

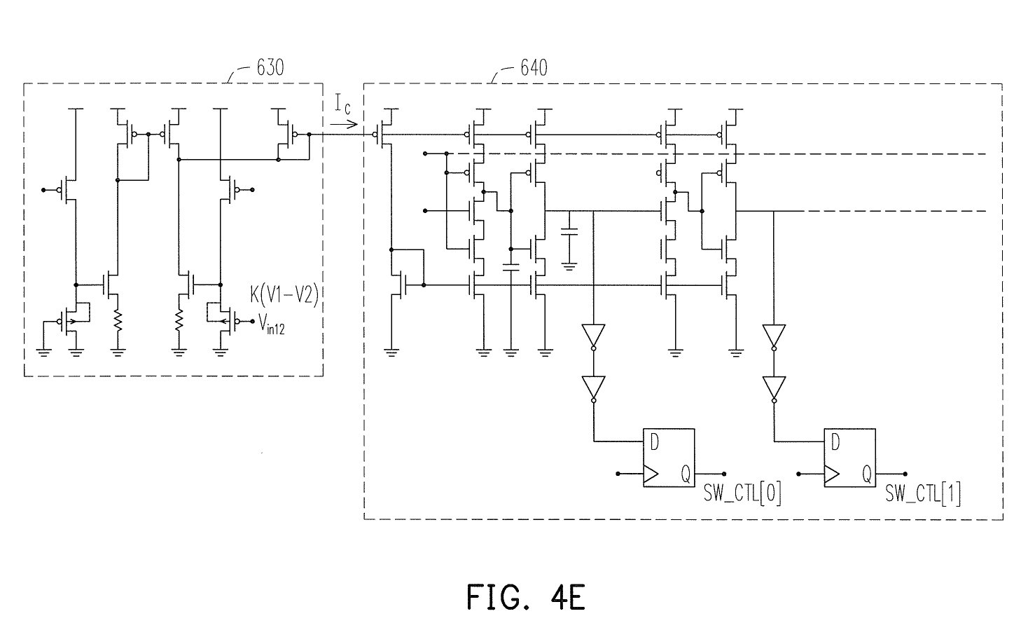

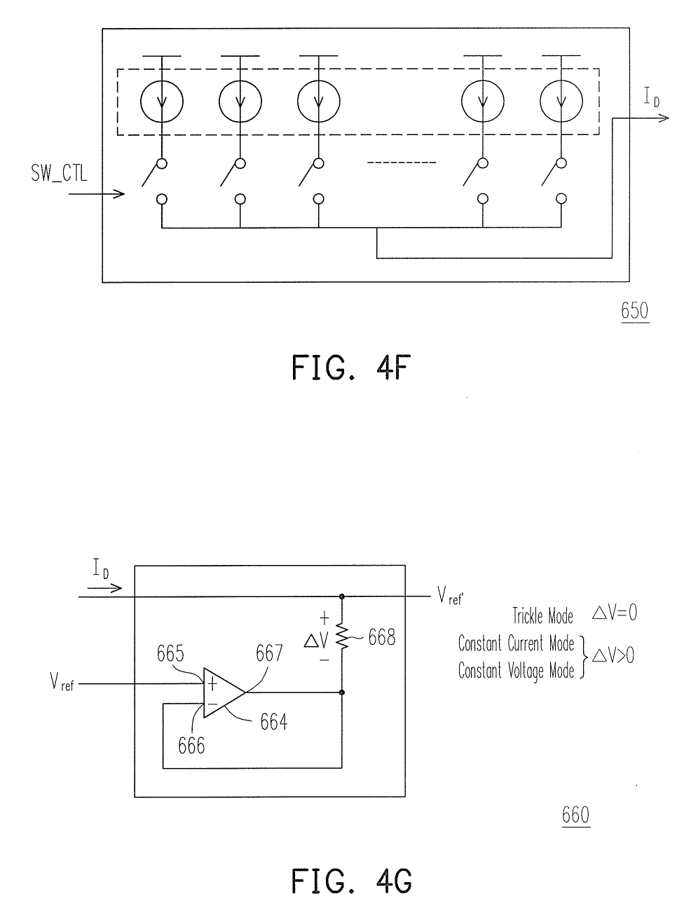

FIG. 4A schematically illustrates a charger 400 charging a battery device 300 according to an embodiment of the present invention. Referring to FIG. 4A, the charger 400 includes a low dropout (LDO) linear regulator 500, a compensation adjusting unit 600, and a controller 700. The LDO linear regulator 500 receives an input voltage VIN. When the charger 400 works, it provides an output voltage VOUT to the battery device 300, and generates a charging current flowing through the battery device 300. The controller 700 is coupled to the LDO linear regulator 500, for controlling a value of the charging current I, and varying a charging mode.

The compensation adjusting unit 600 receives a reference voltage Vref. The compensating adjusting unit 600 is adapted for detecting a variation of the output voltage VOUT (i.e., V1 and V2 which are to be defined herebelow) caused by a transient change of the charging current I. The compensation adjusting unit 600 calculates the resistance value of the parasitic resistor 310 according to the detected transient variation of the output voltage VOUT caused by the transiently changed charging current I. Then, the compensation adjusting unit 600 generates another reference voltage Vref′ according to the calculated resistance value of the parasitic resistor 310, and provides the reference voltage Vref′ to the LDO linear regulator 500, for compensating the IR drop over the parasitic resistor 310. In other words, working under the constant current mode, when resistance value of the parasitic resistor 310 is detected, the reference voltage Vref′ is then outputted to the LDO linear regulator 500. In such a way, the voltage over the two ends of the battery 320 can fast reach the specific voltage Vp.

FIG. 4B is a circuit diagram of the LDO linear regulator 500 provided by an embodiment of the present invention. The LDO linear regulator 500 is depicted for illustrating the spirit of the present invention without restricting the scope of the present invention. The LDO linear regulator 500 includes an operational amplifier 510, a switch 520, a first resistive divider 530, and a second resistive divider 540. The operational amplifier 510 includes a non-inverting terminal 511, an inverting terminal 512, and an amplifier output terminal 513. The inverting terminal is coupled to the compensation adjusting unit 600, for receiving the reference voltage Vref′.

The switch 520 includes a switch control terminal 521, a switch input terminal 522, and a switch output terminal 523. The switch control terminal 521 is coupled to the amplifier output terminal 513 of the operational amplifier 510. The switch input terminal 522 is adapted for receiving the input voltage VIN. The switch output terminal 523 is adapted for providing the output voltage VOUT to the battery device 300, and generating the charging current I flowing through the battery device 300.

The switch 520 can be a transistor as shown in FIG. 4B. For example, the control terminal 521 of the switch 520 is a gate of the transistor, the input terminal 522 of the switch is the drain of the transistor, and the output terminal 523 of the switch 520 is a source of the transistor. However, it should be noted that the switch can be but is not restricted to be a switch. The first resistive divider 530 has one end coupled to the output terminal 523 of the switch 520, and another end coupled to the non-inverting terminal 511 of the operational amplifier 510. The second resistive divider 540 has one end coupled to the non-inverting terminal 511 of the operational amplifier 510, and another end grounded.

FIG. 4C is a circuit diagram of the compensation adjusting unit 600 provided by an embodiment of the present invention. Referring to FIG. 4C, the compensation adjusting unit 600 includes a voltage compensation unit 610, and a voltage level adjusting unit 620. The voltage compensation unit 610 is adapted for detecting a variation of the output voltage VOUT caused by a transient change of the charging current I. The voltage compensation unit 610 calculates the resistance value of the parasitic resistor 310 according to the detected transient variation of the output voltage VOUT caused by the transiently changed charging current I, thus generating a first compensation voltage K(V1-V2) which is adapted for and capable of compensating the IR drop over the parasitic resistor 310. K is a constant and is to be further defined herebelow.

The voltage level adjusting unit 620 is coupled between the voltage compensation unit 610 and the LDO regulator 500, for receiving the reference voltage Vref. The voltage level adjusting unit 620 receives the first compensation voltage K(V1-V2) from the voltage compensation unit 610, and accumulately adds the first compensation voltage K(V1-V2) to the reference voltage Vref, thus generating the reference voltage Vref′. The reference voltage Vref′ is then provided to the LDO linear regulator 500, for compensating the IR drop over the parasitic resistor 310.

FIG. 4D is a circuit block diagram of a voltage level adjusting unit 620 provided by an embodiment of the present invention. The voltage level adjusting unit 620 includes a voltage-to-current converter 630, an inverter chain 640, a digital current source 650, and a voltage accumulation unit 660. The voltage-to-current converter 630 is coupled to the voltage compensation unit 610, for converting the first compensation voltage K(V1-V2) into a first compensation current Ic. The inverter chain 640 is coupled to the voltage-to-current converter 630, for converting the first compensation current Ic into a digital code SW_CTL.

FIG. 4E is a circuit diagram of the voltage-to-current converter 630 and the inverter chain 640 provided by an embodiment of the present invention without restricting the scope of the present invention. As shown in FIG. 4E, the first compensation voltage K(V1-V2) is inputted from Vᵢₙ₁₂ of FIG. 4E, and the digital code SW_CTL is represented by SW_CTL[0], and SW_CTL[1], etc., in FIG. 4E. Internal elements and coupling relationship of the voltage-to-current converter 630 and the inverter chain 640 can be learnt by referring to FIG. 4E, and are not to be iterated hereby.

Although the parasitic resistance value of each individual battery device 300 differs from others, the parasitic resistance value falls within a certain range. As such, each of the first compensation voltage K(V1-V2), the first compensation current Ic, and the digital code SW_CTL also falls within a certain range. The first compensation voltage K(V1-V2) is converted into the first compensation current Ic by the voltage-to-current converter 630 for driving the inverter chain 640. The first compensation current Ic is in inverse proportion to a transmission time of signals, so that different first compensation currents Ic cause delay variations of the inverter chain 640. The delay variations of the inverter chain 640 further determine different digital code SW_CTL. In such a way, the obtained digital code SW_CTL can be accorded for compensating the IR drop over the parasitic resistor 310.

The digital current source 650 is coupled to the inverter chain 640, for determining a value of a current I_{D} according to the digital code SW_CTL generated by the inverter chain 640. FIG. 4F is a circuit diagram of the digital current source 650 provided by an embodiment of the present invention without restricting the scope of the present invention. Internal elements and coupling relationship of the digital current source 650 can be learnt by referring to FIG. 4F, and are not to be iterated hereby.

The voltage accumulation unit 660 is coupled between the digital current source 650 and the LDO linear regulator 500, for receiving the reference voltage Vref. The voltage accumulation unit 660 also receives the current I_{D} from the digital current source 650, and is adapted for generating the reference voltage Vref′ according to the current I_{D} and providing the reference voltage Vref′ to the LDO linear regulator 500, for compensating the IR drop over the parasitic resistor 310.

FIG. 4G is a circuit diagram of the voltage accumulation unit 660 provided by an embodiment of the present invention without restricting the scope of the present invention. The voltage accumulation unit 660 includes a first operational amplifier 664, and an accumulation resistor 668. The first operational amplifier 664 includes a first non-inverting input terminal 665, a first inverting input terminal 666, and a first output terminal 667. The first non-inverting input terminal 665 is adapted for receiving the reference voltage Vref. The first inverting input terminal 666 is coupled to the first output terminal 667.

One end of the accumulation resistor 668 is coupled to the digital current source 650 and the LDO linear regulator 500, and another end of the accumulation resistor 668 is coupled to the first output terminal 667. Because the accumulation resistor 668 is coupled with the digital current source 650, the current I_{D} flows by the accumulation resistor 668, and configures an accumulation voltage ΔV over the two ends of the accumulation resistor 668. The accumulation resistor 668 is further coupled with the LDO linear regulator 500, and therefore the voltage received by the LDO linear regulator 500 is equal to a sum of the accumulation voltage ΔV and the reference voltage Vref. In other words, the reference voltage Vref′ is equal to the sum of the accumulation voltage ΔV and the reference voltage Vref.

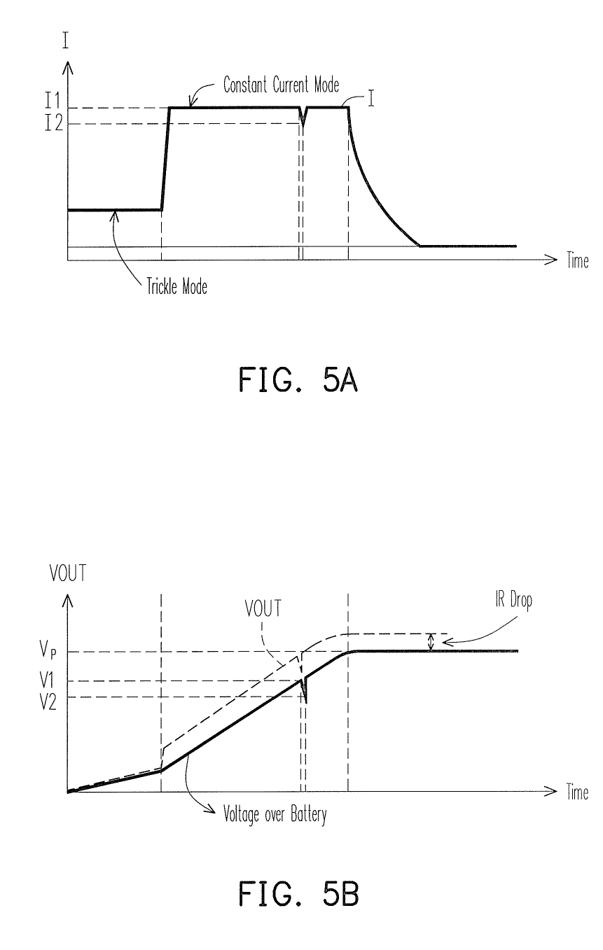

The parasitic resistance 310 can be calculated by the compensation adjusting unit 600. Details can be learnt by referring to FIGS. 5A and 5B. Referring to FIGS. 4A, 5A and 5B, when the charger works in the constant current mode (as shown in FIG. 5A, the charging current I in the constant current mode is I1), a controller 700 promptly turns down charging current I a little (from I1 to I2 as shown in FIG. 5A). Because the charging current I is promptly turned down, the battery 320 is functionally similar with a capacitor when being charged. As such, the voltage applied over the two ends of the battery 320 is almost unchanged during such a short period, and can be considered as a constant Vcons. It can be known from FIG. 5B that when the charging current I is I1, the output voltage VOUT is V1, and when the charging current I is changed from I1 to I2, the output voltage VOUT becomes V2. Supposing that the resistance value of the parasitic resistor 310 is R, then equations (2) and (3) as following can be obtained.

V1=I1·R+Vcons (2), and

V2=I2·R+Vcons (3).

Equation (4) for calculating R can be deducted from equations (2) and (3) as:

$$R = \frac{V 2 - V 1}{I 2 - I 1} \qquad ( 4 )$$

As such, if only V1, V2, I1, and I2 are known, the resistance value of the parasitic resistor R can be obtained. Meanwhile, the IR drop I1×R can also be learnt. According to the relationship between the first resistive divider 530 and the second resistive divider 540 (the resistance of the first resistive divider 530 is R1, and the resistance of the second resistive divider 540 is R2), the first compensation voltage K(V1-V2) for compensating the IR drop I1×R over the parasitic resistor 310 can be represented as:

$$K ( V 1 - V 2 ) = I 1 \times R \times \frac{R 2}{R 1 + R 2} = I 1 \times \frac{V 1 - V 2}{I 1 - I 2} \times \frac{R 2}{R 1 + R 2} , \qquad ( 5 )$$

in which

$$K = I 1 \times \frac{1}{I 1 - I 2} \times \frac{R 2}{R 1 + R 2} .$$

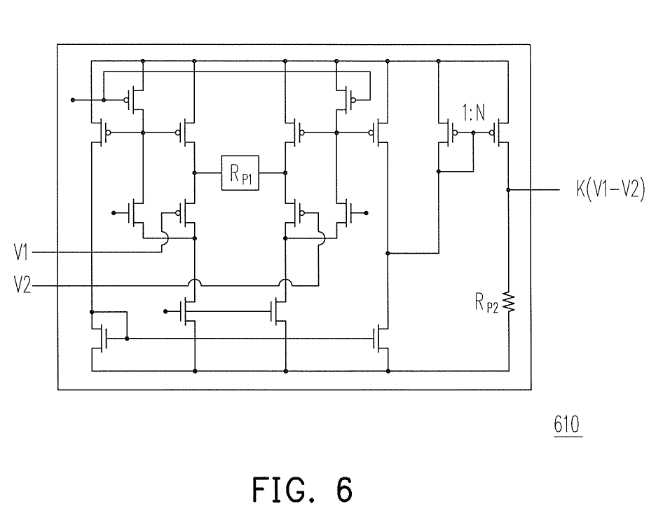

As such, the voltage compensation unit 610 can be a P compensator for calculating the first compensation voltage K(V1-V2). FIG. 6 is a circuit diagram of a voltage compensation unit 610 provided by an embodiment of the present invention. The voltage compensation unit 610 is a P compensator. However, this is not for restricting the scope of the present invention. Internal elements and coupling relationship of the voltage compensation unit 610 can be learnt by referring to FIG. 6, and are not to be iterated hereby. Referring to FIG. 6, the output voltages V1 and V2 are inputted in the voltage compensation unit 610, the voltage compensation unit 610 generates the first compensation voltage K(V1-V2) as following.

$$K ( V 1 - V 2 ) = \frac{( V 1 - V 2 )}{{R}_{P 1}} \times N \times {R}_{P 2} . \qquad ( 6 )$$

### Designing the

$$N \times {R}_{P 2} \times \frac{1}{{R}_{P 1}}$$

in the equation (6) to be K, the calculation of the parasitic resistor 310 is then completed. Meanwhile, the first compensation voltage K(V1-V2) for compensating the IR drop over the parasitic resistor 310 can also be calculated.

After being operated by the voltage level adjusting unit 620, the first compensation voltage K(V1-V2) generates the reference voltage Vref′ and provides the reference voltage Vref′ to the LDO linear regulator 500. Then, after being operated by the LDO linear regulator 500, the voltage over the two ends of the battery device 300 can be charged to a sum of the specific voltage Vp and the IR drop over the parasitic resistor 310, while the voltage over the two ends of the battery 320 can be charged to the specific voltage Vp. In such a way, the charger is delayed to enter the constant voltage mode, so that the charging period of the constant current mode is increased. As such, the affection caused by IR drop over the parasitic resistor 310 is reduced, and the charge rate is improved.

In summary, the charger according to the embodiments of the present invention is capable of obtaining a resistance value of the parasitic resistance of the battery device, and thus obtaining the current resistor voltage drop for compensating. As such, the charger according to the embodiments of the present invention is adapted for accurately charging a battery in a battery device to a specific voltage, with an improved charging performance. Further, the charger according to the embodiments of the present invention is adapted for charging the battery in the battery device to a specific voltage with an improved charge rate, thus saving the time spent on charging.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A battery charging system, adapted for compensating a parasitic resistance of a battery device, and the battery device further comprising a battery, the charger comprising:
a regulator, for providing a charging current to the battery device;
a controller, coupled to the regulator, for controlling the charging current outputted from the regulator; and
a compensation adjusting unit, coupled to the regulator and the battery device, for receiving a first reference voltage,
wherein when the charger enters a first operation mode, the compensation adjusting unit outputs the first reference voltage to the regulator; and
when the charger enters a second operation mode, the controller instructs the regulator to transiently generate a first charging current and a second charging current, and responsive to the first charging current and the second charging current, an output voltage of the battery device presents a first output voltage and a second output voltage, respectively, and the compensation adjusting unit pre-estimates a resistance value of the parasitic resistance of the battery device by detecting the first output voltage and the second output voltage, so as to compensate the first reference voltage.

2. The battery charging system according to claim 1, wherein the compensation adjusting unit comprises:
a voltage compensation unit, coupled to the regulator, wherein the voltage compensation unit outputs an output signal related to a difference between the first output voltage and the second output voltage; and
a voltage level adjusting unit, for receiving the output signal outputted from the voltage compensation unit to compensate the first reference voltage.

3. The battery charging system according to claim 2, wherein the voltage level adjusting unit comprises:
a voltage-to-current converter, coupled to the voltage compensation unit, for converting the output signal outputted from the voltage compensation unit into a first current;
an inverter chain, coupled to the voltage-to-current converter, for converting the first current into a digital code;
a digital current source, coupled to the inverter chain, for determining a second current according to the digital code; and
a voltage accumulation unit, coupled to the digital current source, and adapted for outputting a compensation voltage according to the second current, wherein the compensation voltage is provided for compensating the first reference voltage.

4. The battery charging system according to claim 3, wherein the voltage accumulation unit comprises:
an operational amplifier, comprising:
a first input terminal, coupled to the first reference voltage;
a second input terminal; and
an output terminal, coupled to the second input terminal; and
a resistor, having one end receiving the second current, and another end coupled to the output terminal of the operational amplifier,
wherein the compensation voltage is related to a voltage drop over the resistor.

5. A charger, adapted for compensating a parasitic resistance of a battery device, and the battery device further comprising a battery, the charger comprising:
a regulator, providing a charging current to the battery device, wherein the battery device generates an output voltage responsive to the charging current;
a controller, coupled to the regulator, for controlling the charging current outputted from the regulator;
a voltage compensation unit, coupled to the regulator, wherein the voltage compensation unit outputs an output signal related to a difference caused by a transient variation of the output voltage;
a voltage-to-current converter, coupled to the voltage compensation unit, for converting the output signal outputted from the voltage compensation unit into a first current;
an inverter chain, coupled to the voltage-to-current converter, for converting the first current into a digital code;
a digital current source, coupled to the inverter chain, for determining a second current according to the digital code; and
a voltage accumulation unit, coupled to the digital current source, for receiving a first reference voltage, and outputting a compensation voltage according to the second current, wherein the compensation voltage is provided for compensating the first reference voltage,
wherein when the charger enters a first operation mode, the voltage accumulation unit outputs the first reference voltage to the regulator; and
when the charger enters a second operation mode, the controller instructs the regulator to transiently generate a first charging current and a second charging current, and responsive to the first charging current and the second charging current, the output voltage of the battery device presents a first output voltage and a second output voltage, respectively, and the voltage compensation unit pre-estimates a resistance value of the parasitic resistance of the battery device by detecting the first output voltage and the second output voltage, so as to compensate the first reference voltage.

6. The charger according to claim 5, wherein the voltage accumulation unit comprises:
an operational amplifier, comprising:
a first input terminal, coupled to the first reference voltage;
a second input terminal; and
an output terminal, coupled to the second input terminal; and
a resistor, having one end receiving the second current, and another end coupled to the output terminal of the operational amplifier,
wherein the compensation voltage is related to a voltage drop over the resistor.

7. A method of providing a battery device with a charging current for compensating a parasitic resistance thereof, the method comprising:
generating an output voltage responsive to the charging current;
outputting an output signal related to a difference caused by a transient variation of the output voltage;
converting the output signal into a first current;
converting the first current into a digital code;
determining a second current according to the digital code; and
receiving the first reference voltage, and outputting a compensation voltage according to the second current,
wherein the compensation voltage is provided for compensating the first reference voltage.

8. The method according to claim 7 further comprising:
outputting the first reference voltage when entering a first operation mode.

9. The method according to claim 7 further comprising:
generating a first charging current and a second charging current when entering a second operation mode;
presenting a first output voltage and a second output voltage according to the first charging current and the second charging current respectively; and
pre-estimating a resistance value of the parasitic resistance of the battery device by detecting the first output voltage and the second output voltage, so as to compensate the first reference voltage.
